(19) United States
(12) Patent Application Publication
(10) Pub. No.: US 2012/0194908 A1
(43) Pub. Date: Aug. 2, 2012

(54) 3D to 2D Polarized Down converting Glasses

(76) Inventor: Jason Trinklein, Mount Pleasant, SC (US)

(21) Appl. No.: 13/019,933

(22) Filed: Feb. 2, 2011

(51) Int. Cl. G02B 5/30; G02B 5/20

(52) U.S. Cl. 359/492.01; 359/892

(57) ABSTRACT

A device to convert 3-D video to 2-D video may include a source of 3-D video to project a 3-D video image and a 2-D conversion device to convert the 3-D video image to a 2-D video image and to be worn by the user. The 2-D conversion device may be glasses having a first lens and a second lens, wherein the first lens and the second lens has the same type of filter, and the type of filter may be a linear polarization filter.

### FIELD OF THE INVENTION

The present invention relates to a device to be used in polarized 3D stereoscopic multimedia presentations such as in 3D movie theaters and 3D home entertainment systems, more particularly the present invention relates to and includes a pair of glasses that when worn in the aforementioned presentations or other similar presentation may down-convert the 3D image to 2D.

### BACKGROUND

The predominant technology used for stereoscopic separation is passive polarized eyewear. Each of the lenses in the pair of glasses is designed to filter specific forms of polarization so that each eye receives a distinct image. There are two types of polarization that can be used for this separation: linear and circular. Linear polarization is an older technology that has largely been phased out, whereas circular polarization enjoys the larger market share and resolves some of the disadvantages of linear polarization.

In the physics of polarized electromagnetic radiation and the optical filtering, the polarized electromagnetic radiation by polarization filters is known. Additionally, companies such as RealD™ use polarized light and eyewear polarization filters to produce stereoscopic images in 3D multimedia presentations.

### SUMMARY A device to convert 3-D video to 2-D video may include a source of 3-D video to project a 3-D video image and a 2-D conversion device to convert the 3-D video image to a 2-D video image and to be worn by the user.

The 2-D conversion device may be glasses having a first lens and a second lens, wherein the first lens and the second lens has the same type of filter, and the type of filter may be a linear polarization filter.

The linear polarization filter may be a +45° linear polarization filter, and the linear polarization filter may be a −45° linear polarization filter.

The linear polarization filter may be a 0° linear polarization filter, and the linear polarization filter may be a 90° linear polarization filter.

The type of filter may be a circular polarization filter, and the circular polarization filter may be a clockwise circular polarization filter.

The circular polarization filter may be a counterclockwise circular polarization filter, and the source of 3-D video may be a movie screen.

The source of 3-D video may be a computer screen, and the source of 3-D video may be a TV screen.

The 2-D conversion device may include a first contact lens and a second contact lens.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates 3D glasses and with linear polarization filters at −45 degree and +45 degree alignment;

FIG. 2 illustrates 3D glasses with linear polarization filters at 0 degree and 90 degree alignment;

FIG. 3 illustrates 3D glasses with circular polarization filters;

FIG. 4 illustrates 2D down-converting glasses with linear polarization at substantially +45 degrees and −45 Degrees;

FIG. 5 illustrates 2D down-converting glasses and with linear polarization at substantially 0 degrees and 90 degrees;

FIG. 6 illustrates 2D down-converting glasses with substantially circular polarization in clockwise and counterclockwise orientations;

FIG. 7 illustrates normal 3D operation;

FIG. 8 illustrates 2D down-converting operation;

FIG. 9 illustrates linear polarization;

FIG. 10 illustrates circular polarization.

### DETAILED DESCRIPTION

Many moviegoers, home cinema viewers and other venues have a preference for 2 dimensional video viewing experiences. This preference for two-dimensional video may arise from a mere preference to something as severe as physical ailments following the exposure to a 3D video movie. Some people have reported experiencing headaches, nausea, fatigue, irritation, and other maladies during or after exposure to 3D video in a cinematic, multimedia or other venue content. The present invention will correct or alleviate the adverse effects of three dimensional video. The present invention may include a two-dimensional (2D) conversion device 100 which may include down-converting 2D glasses, goggles, separate lenses such as contact lenses or other appropriate devices to allow a viewer to watch with the same comfort as watching traditional multimedia content, with none or little of the adverse side-affects associated with 3D stereoscopic presentations.

To accomplish 2D down-conversion, the 2-D conversion device 100 such as glasses may include two of the same type of polarized filter lens, one being dedicated for each eye of the user, for example in both sides of the eyewear frame. The 2-D conversion device 100 may include a single lens which covers both eyes of the user, and the 2-D conversion device may be mounted on the head of the user. This arrangement results in each eye to receive the substantially same exact image, which is monoscopic and “2 dimensional”.

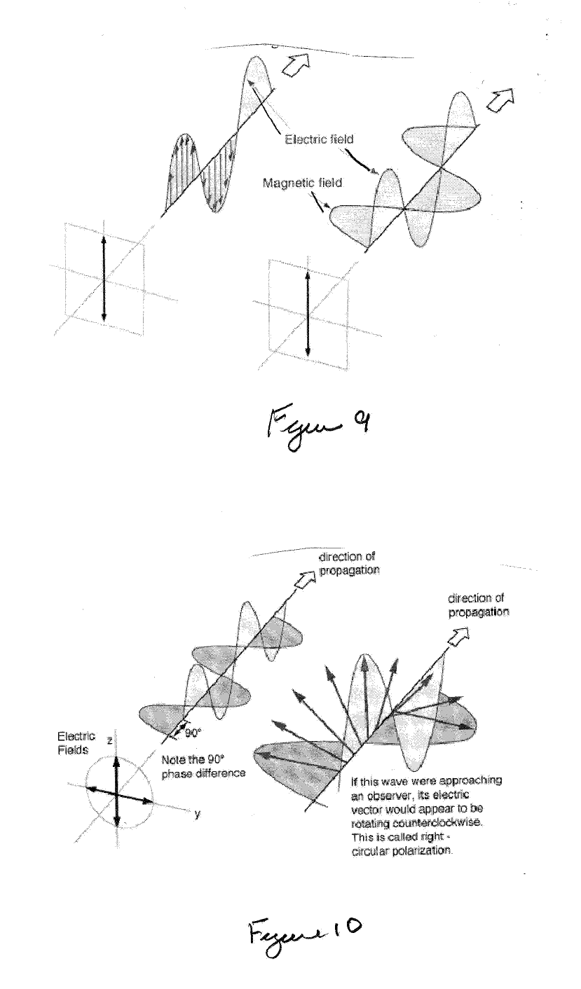

In the case of circular polarization which is shown in FIG. 10, both the left and right lens would be equipped with the same polarization. In the case of linear polarization which is shown in FIG. 9, both the left and right lens would be equipped with the same degree of planar inclination. The exact alignment depends on the theatre's projection technology. For example:

If the 3-D presentation is plus or −45° linear polarization, the 2-D conversion device 100 could be one of the device is shown in FIG. 4. The first and second lenses 102 may be aligned at +45 degrees linear polarization.

Alternatively, the first and second lenses 104 may be aligned at −45 degrees linear polarization.

If the 3-D presentation is at 0° and 90° linear polarization, and the conversion device 100 could be as shown in FIG. 5.

The first and second lenses 106 may be aligned at 0 degrees linear polarization.

The first and second lenses 108 may be aligned at 90 degrees linear polarization

If the 3-D presentation is clockwise and counterclockwise circular polarization, then the 2-D conversion device 100 is illustrated in FIG. 6.

The first and second lenses 110 may be aligned for clockwise circular polarization

Alternatively, the first and second lenses 112 may be aligned for counter-clockwise circular polarization

Linear Polarization as illustrated in FIG. 9 is polarization of light on a two dimensional plane

Circular Polarization as illustrated in FIG. 10 is polarization of light on a rotating plane

Stereoscopic is where each eye receives a unique image that corresponds to natural depth perspectives.

Monoscopic is where each eye receives identical images that corresponds to a two dimensional perspective.

In 3-D, two oppositely polarized video images are projected at a screen or are emitted from a screen towards a viewer. Each image is component of a 3D presentation for stereoscopic imagery. The 2-D conversion device 100 which may be 2D down-converting glasses will contain a first and second lenses that entirely block one of the stereoscopic images, admitting only the second to both of the eyes.

For reference on how this is done, first consider how present 3D stereoscopic filtering is done.

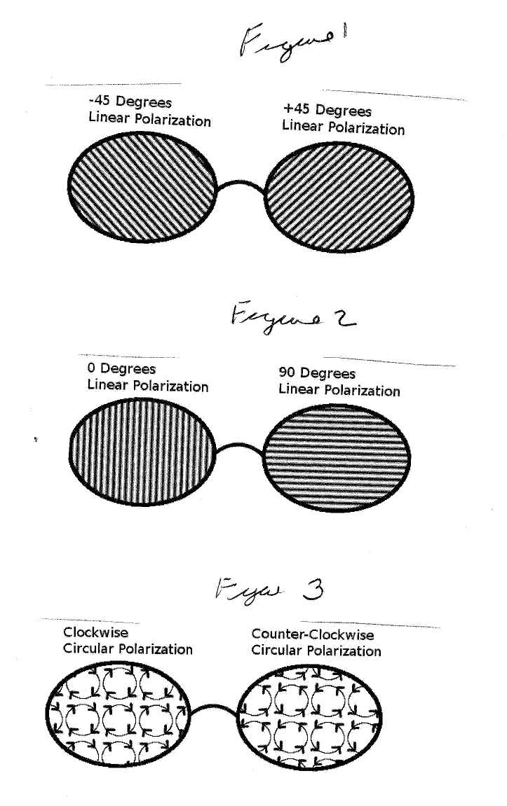

FIG. 1 illustrates linear polarization filters oriented at −45 degrees and +45 degrees. In this case, the images being projected at the viewer are aligned at −45 degrees and +45 degrees, each only being allowed through the respective filter in the eyewear.

FIG. 2 illustrates linear polarization filters oriented at 0 degrees and 90 degrees. In this case, images being projected at the viewer are aligned at 0 degrees and 90 degrees, each only being allowed through the respective filter in the eyewear.

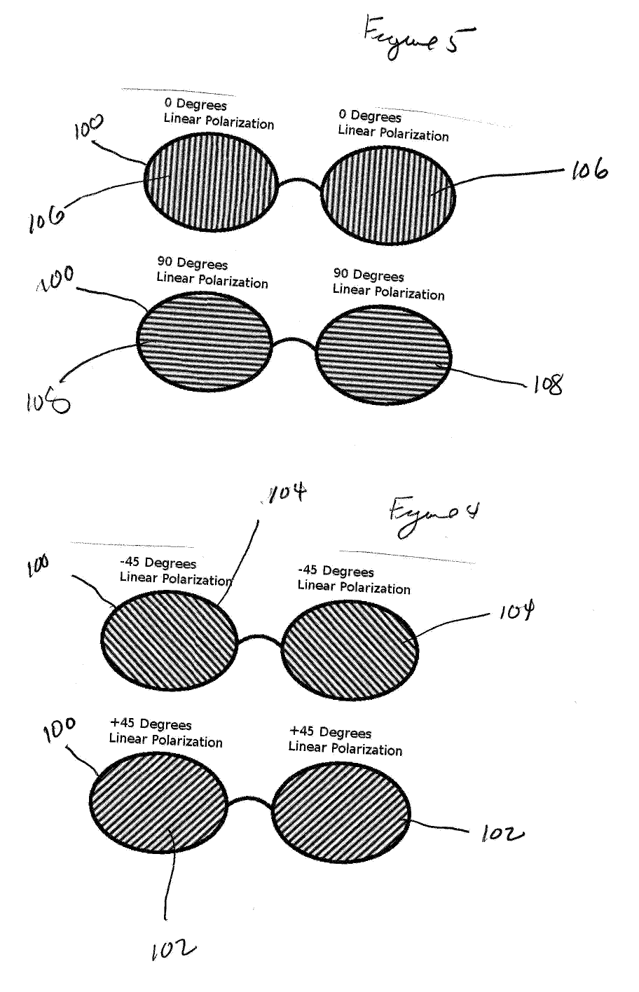

FIG. 3 illustrates circular polarization filters. In this case, images being projected at the viewer are in clockwise and counter-clockwise rotations. The image whose light is rotating in a clockwise direction will be admitted through the polarization filter designed to admit clockwise polarized light, and the image whose light rotating in the counter-clockwise direction will be admitted through the polarization filter designed to admit counter-clockwise polarized light.

FIG. 4 illustrates an example of the present invention and illustrates the 2-D conversion device 100 which may be a linear polarization 2D down-converting pair of glasses where first and second lenses 102 may be oriented the same and are oriented in +45 degrees permitting only a +45 degree polarized image or where the first and second lenses 104 in −45 degrees, permitting only a −45 degree polarized image, respectively, so that each eye receives the same 2D image.

FIG. 5 illustrates an example of the of the 2-D conversion device 100 and illustrates a linear polarization 2D down-converting pair of glasses where the first and second lenses 106 are oriented in a 0 degrees. permitting substantially only a 0 degree polarized image or where the first and second lens 108 in a 90 degrees orientation, permitting a 90 degree polarized image, respectively, so that each eye receives the same 2-D image.

FIG. 6 illustrates another example of the 2-D conversion device 100 and illustrates a circular polarization 2D down-converting pair of glasses where first and second lenses 110 admit substantially only clockwise polarized light, permitting only clockwise circularly polarized images, so that each eye receives the same 2-D image.

FIG. 6 illustrates another example of the 2-D communication device 100 and illustrates a circular polarization 2D down-converting pair of glasses where first and second lenses 112 admit substantially only counter-clockwise polarized light, permitting only clockwise circularly polarized images, so that each eye receives the same 2-D image.

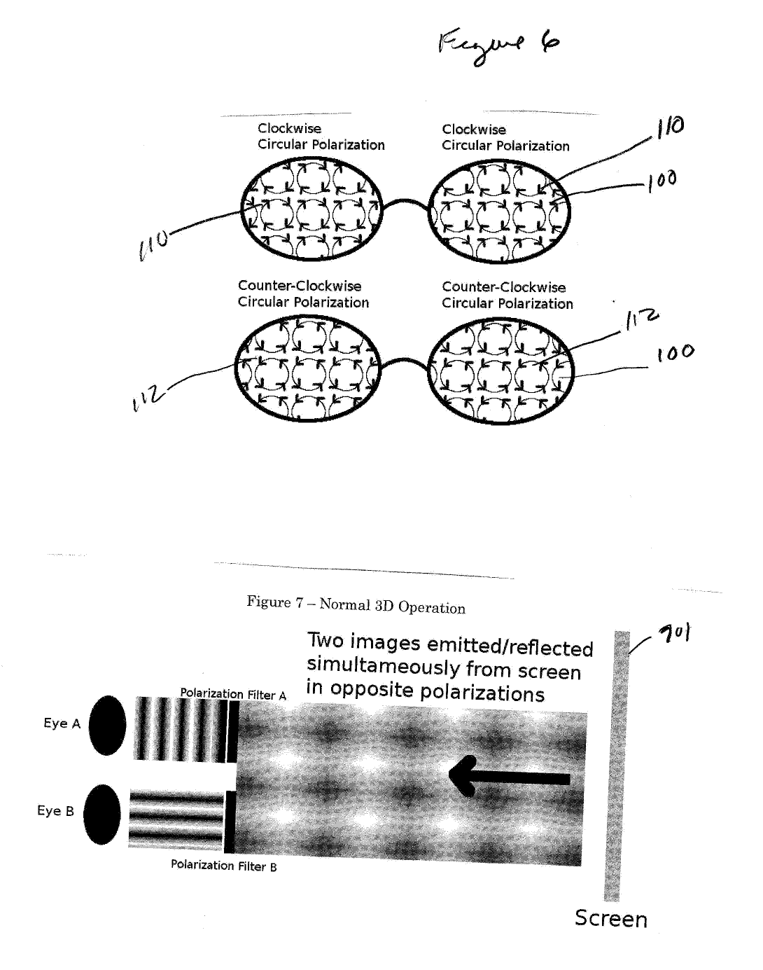

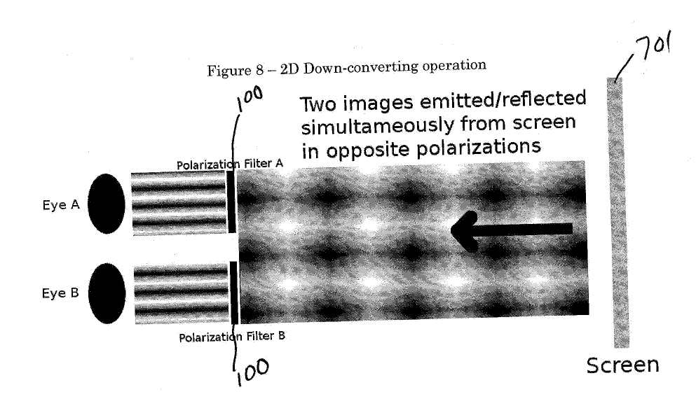

FIG. 7 illustrates how normal 3D stereoscopy in multimedia presentations operates. The 3-D video image is projected from the screen 701 with light traveling towards the viewer, containing both of the opposite types of polarized light. When 3-D video image is incident on the filters (filter A and filter B) being worn by the viewer, each eye receives the opposite form of polarized light and two different images.

FIG. 9 illustrates how 2D monoscopic down-conversion in multimedia presentations operates. The 3-D video image is projected from a source 701 of 3-D video such as the screen 701 towards the viewer and the 3-D video image includes light traveling towards the viewer, containing both of the opposite types of polarized light. When the 3-D light images incident on the (same) filters of the 2-D conversion device 100 as described herein and being worn by the viewer, each eye receives substantially identical polarized light signals, and hence, the substantially plan same 2-D image to both eyes.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A device to convert 3-D video to 2-D video, comprising:
a source of 3-D video to project a 3-D video image;
a 2-D conversion device to convert the 3-D video image to a 2-D video image and to be worn by the user.

2) A device to convert 3-D video to 2-D video as in claim 1, wherein the 2-D conversion device is glasses having a first lens and a second lens, wherein the first lens and the second lens has the same type of filter.

3) A device to convert 3-D video to 2-D video as in claim 2, wherein the type of filter is a linear polarization filter.

4) A device to convert 3-D video to 2-D video as in claim 3, wherein the linear polarization filter is a +45° linear polarization filter.

5) A device to convert 3-D video to 2-D video as in claim 3, wherein the linear polarization filter is a −45° linear polarization filter.

6) A device to convert 3-D video to 2-D video as in claim 3, wherein the linear polarization filter is a 0° linear polarization filter.

7) A device to convert 3-D video to 2-D video as in claim 3, wherein the linear polarization filter is a 90° linear polarization filter.

8) A device to convert 3-D video to 2-D video as in claim 2, wherein the type of filter is a circular polarization filter.

9) A device to convert 3-D video to 2-D video as in claim 8, wherein the circular polarization filter is a clockwise circular polarization filter.

10) A device to convert 3-D video to 2-D video as in claim 8, wherein the circular polarization filter is a counterclockwise circular polarization filter.

11) A device to convert 3-D video to 2-D video as in claim 1, wherein the source of 3-D video is a movie screen.

12) A device to convert 3-D video to 2-D video as in claim 1, wherein the source of 3-D video is a computer screen.

13) A device to convert 3-D video to 2-D video as in claim 1, wherein the source of 3-D video is a TV screen.

14) A device to convert 3-D video to 2-D video him lose as in claim 1, wherein the 2-D conversion device includes a first contact lens and a second contact lens.
